(19) United States
(12) Patent Application Publication
(10) Pub. No.: US 2025/0130312 A1
(43) Pub. Date: Apr. 24, 2025

(54) SYSTEMS AND METHODS FOR INSERTINGWATERMARKS IN RADAR SIGNALS FOR ELECTRONIC COUNTER-COUNTERMEASURES

(71) Applicant: MOTOROLA SOLUTIONS, INC., Chicago, IL (US)

(72) Inventors: SUMIT A. TALWALKAR, WESTON, FL (US); GARY E. WESTERN, ANNAPOLIS, MD (US); KRISTEN A. LASICA-KHANER, ALEXANDRIA, VA (US)

(21) Appl. No.: 18/489,077

(22) Filed: Oct. 18, 2023

(51) Int. Cl. G01S 7/36; G01S 7/292

(52) U.S. Cl. CPC G01S 7/36; G01S 7/292

(57) ABSTRACT

Systems and methods for inserting watermarks in radar signals for electronic counter-countermeasures are provided. An example radar system generates a radar signal comprising a plurality of rising and falling edges and inserts a watermark into the radar signal by applying a time shift to a particular one of the rising and falling edges. The radar system then determines whether a received radar signal includes a time-shifted rising or falling edge corresponding to the inserted watermark and responsively determines whether the received radar signal is a skin return signal or an electronic countermeasure signal.

### BACKGROUND

Radar systems allow for detecting and tracking objects by emitting radio waves and analyzing their reflections. The emitted radio waves travel through space until they encounter an object, at which point they bounce back and return to the radar system as echoes. By measuring the time it takes for the radio waves to travel to the object and back, along with the properties of the returned signals, radar systems can determine the distance, speed, and direction of the detected objects. This information is then processed to track moving targets, assist in navigation, generate detailed maps, and provide valuable data for various applications, such as weather forecasting, air traffic control, and military operations.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1A is a simplified diagram of an environment of an example radar system.

FIG. 1B is a simplified diagram of an environment of an example radar system employing watermark insertion and detection techniques.

FIG. 2A is a simplified diagram of an example radar signal before receiving a watermark and after receiving a watermark.

FIG. 2B is a simplified diagram of an example radar signal before receiving a watermark and after receiving a watermark.

FIG. 2C is a simplified diagram of an example radar signal before receiving a watermark and after receiving a watermark.

FIG. 3A is a flowchart of an example method for generating and transmitting a watermarked radar signal as an electronic counter-countermeasure.

FIG. 3B is a flowchart of an example method for determining whether a received radar signal is an electronic countermeasure signal or a skin return signal.

FIG. 4 is a simplified diagram of an example computing device for inserting and detecting watermarks in radar signals for electronic counter-countermeasures.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

One problem with conventional radar systems is that they are vulnerable to electronic countermeasures (ECM), which include techniques that aim to disrupt or deceive radar systems, preventing them from accurately detecting and tracking targets. ECM techniques can take various forms, and examples include jamming techniques and deception techniques. Jamming techniques may involve transmitting signals at the same or similar frequencies of the radar signal in order to produce a noise level significant enough to camouflage the echo signal. Deception techniques may involve employing signal processing techniques to alter the radar signature and/or create false radar targets, such as by transmitting false radar signals with slight variations in delay relative to echo signals from the actual target, causing the radar system to inaccurately determine the location of the target.

As such, radar systems have been designed to implement various electronic counter-countermeasures (ECCM) to overcome the effects of ECM. ECCM techniques can similarly take various forms and may be suited for negating specific types of ECM techniques. For example, ECCM techniques that allow for more easily distinguishing echo signals from noise generated by jamming ECM techniques may include increasing the power level of the radar signal, applying pulse compression via linear frequency modulation (LFM), frequency hopping, and polarization. However, negating deception ECM techniques can present a much more difficult task, as ECM systems have advanced and are capable of producing false echo signals that are increasingly difficult to distinguish from true echo signals. Thus, there exists a need for an improved technical method, device, and system for employing ECCM techniques to counter ECM deception techniques.

As described in further detail below, the present disclosure is directed toward systems and methods for inserting watermarks into radar signals for ECCM purposes. When using watermarked signals, a radar system can distinguish true echoes, also referred to as “skin returns” or “skin reflections,” from false echoes designed to deceive the radar system. Namely, the radar system can determine that an echo that includes the watermark is a skin return, while an echo that does not include the watermark is an ECM signal.

As used herein, a “watermark” refers to any modification to a radar signal that allows the radar signal to be distinguished from an unmodified version of the radar signal. In order to increase the efficacy of ECCM using watermarked signals, the extent of the watermark modification to the radar signal may be especially small. Modern ECM systems may be capable of detecting larger modifications to a radar signal and may, therefore, be able to generate a false echo that includes the watermark, thereby rendering the ECCM watermark technique useless. Accordingly, the systems and methods described herein may involve applying very slight variations to the radar signal, such that the watermark is undetectable and/or cannot be reproduced by ECM systems.

In accordance with one example embodiment, disclosed herein is a method that involves (i) generating an initial radar signal comprising a plurality of rising and falling edges, (ii) inserting a watermark into the initial radar signal by applying a time shift of a predetermined duration to a particular rising or falling edge from among the plurality of rising and falling edges, thereby producing a watermarked radar signal, (iii) transmitting the watermarked radar signal, (iv) identifying a received radar signal, (v) determining whether the received radar signal includes a time-shifted rising or falling edge corresponding to the inserted watermark, (vi) based on the determination of whether the received radar signal includes the time-shifted rising or falling edge corresponding to the inserted watermark, determining whether the received radar signal is a skin return signal or an electronic countermeasure signal, and (vii) outputting an indication of whether the received radar signal is a skin return signal or an electronic countermeasure signal.

In some embodiments of the method, (i) determining whether the received radar signal includes a time-shifted rising or falling edge corresponding to the inserted watermark comprises determining that the received radar signal does not include a time-shifted rising or falling edge corresponding to the inserted watermark, (ii) determining whether the received radar signal is a skin return signal or an electronic countermeasure signal comprises determining that the received radar signal is an electronic countermeasure signal based on the determination that the received radar signal does not include a time-shifted rising or falling edge corresponding to the inserted watermark, and (iii) outputting the indication of whether the received radar signal is a skin return signal or an electronic countermeasure signal comprises outputting an indication that the received radar signal is an electronic countermeasure signal.

In some embodiments of the method, (i) determining whether the received radar signal includes a time-shifted rising or falling edge corresponding to the inserted watermark comprises determining that the received radar signal does include a time-shifted rising or falling edge corresponding to the inserted watermark, (ii) determining whether the received radar signal is a skin return signal or an electronic countermeasure signal comprises determining that the received radar signal is a skin return signal based on the determination that the received radar signal does include a time-shifted rising or falling edge corresponding to the inserted watermark, and (iii) outputting the indication of whether the received radar signal is a skin return signal or an electronic countermeasure signal comprises outputting an indication that the received radar signal is skin return signal.

In some embodiments of the method, inserting the watermark into the initial radar signal comprises randomly or pseudorandomly selecting the particular rising or falling edge from among the plurality of rising and falling edges in the initial radar signal to be time-shifted by the predetermined duration.

In some embodiments of the method, inserting the watermark into the initial radar signal comprises applying a plurality of respective time shifts to a plurality of respective rising or falling edges from among the plurality of rising and falling edges. And in such embodiments, the plurality of respective time shifts may comprise time shifts of varying durations, such as a first time shift of a first predetermined duration and a second time shift of a second predetermined duration different from the first predetermined duration.

Further, in any embodiment of the method, the predetermined duration of any or all time shifts applied to the radar signal is less than a duration of the inverse of an expected Nyquist frequency of an electronic countermeasure system.

In accordance with another example embodiment, disclosed herein is a radar system that includes one or more processors, a non-transitory computer-readable medium, and program instructions stored on the non-transitory computer-readable medium that are executable by the one or more processors to cause the radar system to carry out the functions disclosed herein, including, but not limited to, the functions of any embodiments of the foregoing method.

In accordance with yet another example embodiment, disclosed herein is a non-transitory computer-readable medium comprising program instructions that are executable to cause a radar system to carry out the functions disclosed herein, including, but not limited to, the functions of any embodiments of the foregoing method.

Each of the above-mentioned embodiments will be discussed in more detail below, starting with example system and device architectures of the system in which the embodiments may be practiced, followed by an illustration of processing blocks for achieving an improved technical method, device, and system for inserting watermarks in radar signals for ECCM.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

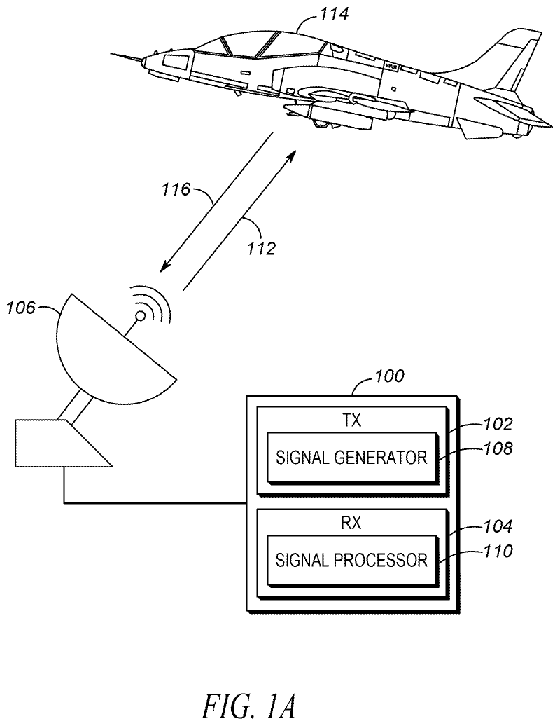

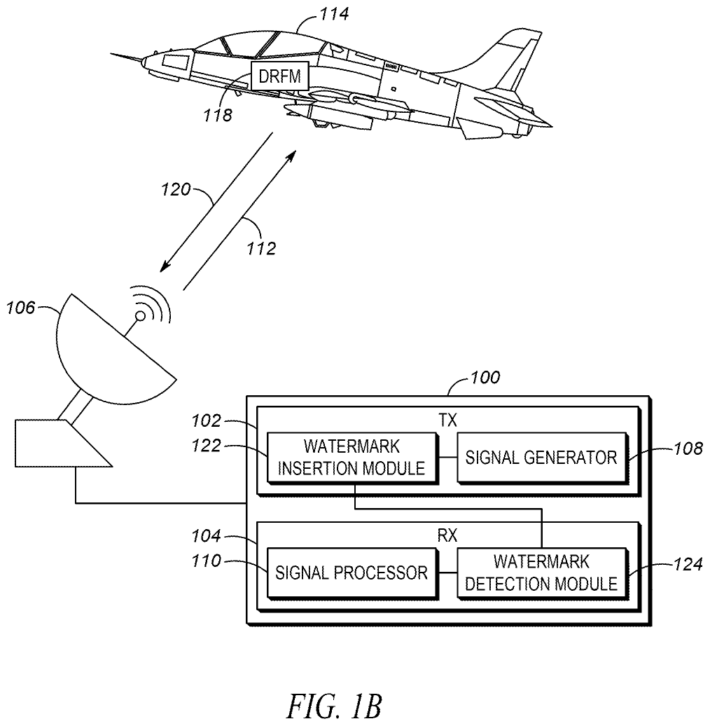

Referring now to the drawings, and in particular FIG. 1A, a simplified diagram of an environment for using a conventional radar system 100 is depicted. As shown, the radar system 100 includes a transmitter 102, a receiver 104, and one or more transmitting and receiving antennas 106. The transmitter 102 includes a radar signal generator 108, and the receiver 104 includes a signal processor 110. While FIG. 1A depicts the transmitting and receiving antennas 106 as a single antenna, it should be understood that the transmitting and receiving antennas 106 may be implemented as separate antennas. Further, the transmitting and receiving antennas 106 may be co-located with one another, as is the case in monostatic radar systems, or may be separated from one another by a distance, as is the case in bistatic or multistatic radar systems.

In operation, the radar signal generator 108 generates a radar signal. The radar signal may take various forms and may be, for instance, a pulse modulated radar signal (e.g., an LFM radar signal) or a continuous wave (CW) radar signal. The transmitter 102 amplifies the radar signal and causes the transmitting antenna 106 to transmit the radar signal 112. In some implementations, the transmitting antenna 106 may be configured to focus the transmitted radar signal 112 in a particular direction (e.g., at particular azimuth and/or altitude angles). If an object, such as the aircraft 114 depicted in FIG. 1A, is present in the direction of the transmitted radar signal 112, then at least some of the transmitted radar signal 112 reflects off the object 114 as a skin return signal 116. The reflected skin return signal 116 travels back to the receiving antenna 106, which receives the skin return signal 116 and provides the skin return signal 116 to the receiver 104. The receiver 104 amplifies the skin return signal 116, and the signal processor 110 applies a filter to isolate the skin return signal 116 from background noise and interference.

The signal processor 110 further processes the skin return signal 116 using time-domain and/or frequency-domain analyses to determine positional information of the object 114 based on characteristics of the skin return signal 116. In some examples, the signal processor 110 may determine a time-of-flight measurement by measuring the time it took for the radar signal to travel from the transmitting antenna 106 to the aircraft 114 and back to the receiving antenna 106 in the form of the skin return signal 116. Further, in some examples, the signal processor 110 may perform Doppler processing to measure a frequency shift in the skin return signal 116 and, based on the measured frequency shift, determine a velocity of the aircraft 114. Still further, in examples where the transmitted radar signal 112 is an LFM radar signal, the signal processor 110 may apply pulse compression techniques to the skin return signal 116 to improve the range resolution of the radar system 100, which may allow for distinguishing between closely spaced targets. Additionally or alternatively, the signal processor 110 may perform any other signal processing techniques now known or later developed for processing radar signals.

Based on the signal processing performed by the signal processor 110, the radar system determines various characteristics of the aircraft 114. Examples of such characteristics can include, but are not limited to, position (e.g., range, azimuth, altitude), velocity, heading, and size.

In some circumstances, however, the aircraft 114 may employ ECM techniques, thereby causing the radar system 100 to determine inaccurate characteristics of the aircraft 114 or fail to detect the aircraft 114 entirely. As noted above, ECM techniques can take various forms including deceptive techniques designed to deceive the radar system 100 as to the true position, velocity, heading, or size of the aircraft 114.

One example of a deceptive ECM technique involves the use of a digital radio frequency memory (DRFM) system. A DRFM system is configured to capture incoming radar signals, digitally process them, and retransmit them with modifications designed to deceive the radar system. As such, a DRFM system essentially creates electronic decoys or false targets that can confuse or mislead the radar system 100.

FIG. 1B depicts an environment in which the aircraft 114 is employing a DRFM system 118 to deceive the radar system 100. In operation, when the radar system 100 emits the radar signal 112, the DRFM system 118 intercepts the radar signal 112 using a high-frequency receiver. The intercepted signal 112 is then digitized using an analog-to-digital converter (ADC), thereby creating a digital representation of the radar signal 112. The digital radar signal is then processed in real-time using advanced digital signal processing (DSP) techniques to manipulate the signal. One example manipulation may include frequency shifting so that the Doppler processing performed by the radar system 100 will result in the determination of an inaccurate velocity of the aircraft 114. Another example manipulation may include a time delay manipulation so that the time-of-flight measurement performed by the radar system 100 will result in the determination of an inaccurate distance of the aircraft 114 from the radar system 100. The DRFM system 118 may perform various other signal manipulations as well, such as amplitude modulation and/or phase modulation.

After manipulating the digitized radar signal, the DRFM system 118 retransmits the modified radar signal 120 back toward the radar system 100. The radar system 100 receives the modified radar signal 120 and processes the signal 120 using any of the various signal processing techniques described above to determine a position, velocity, heading, and/or size of the aircraft 114. However, because the DRFM system 118 manipulated the radar signal 112 and retransmitted the modified radar signal 120 back to the radar system 100, the radar system 100 may fail to accurately determine the various characteristics of the aircraft 114. Accordingly, when using radar to detect an object such as the aircraft 114, it is advantageous to know whether the signal returned to the radar system 100 is a skin return signal 116 or is instead an ECM signal, such as the modified radar signal 120 transmitted by the DRFM system 118.

In order to help determine whether a return signal received by the radar system 100 is a skin return signal 116 or an ECM signal 120, the radar system 100 may be configured with additional functionality for making such a determination. For example, as depicted in FIG. 1B, the transmitter 102 of the radar system 100 may include a watermark insertion module 122, and the receiver 104 of the radar system 100 may include a watermark detection module 124.

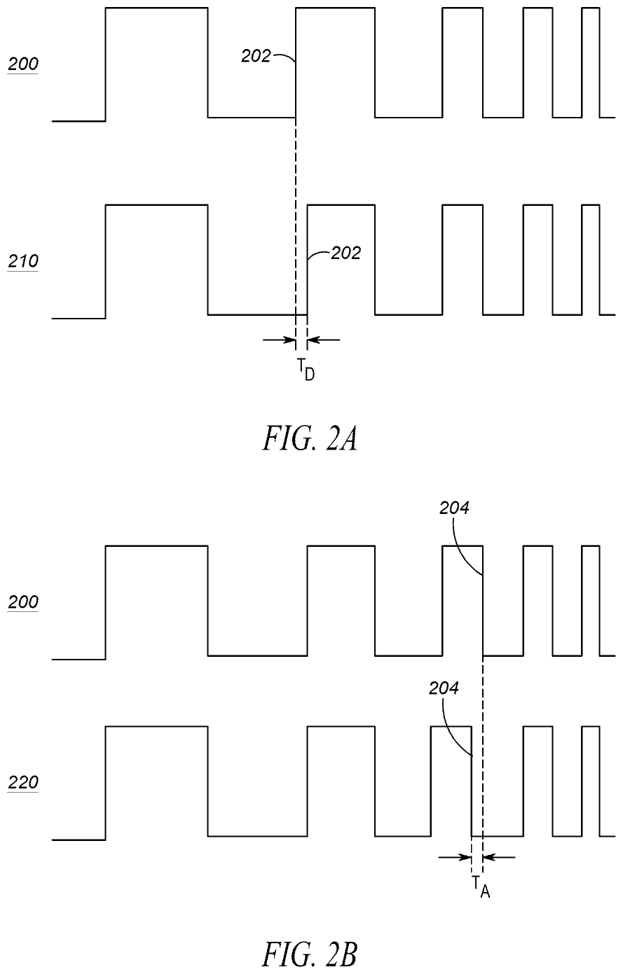

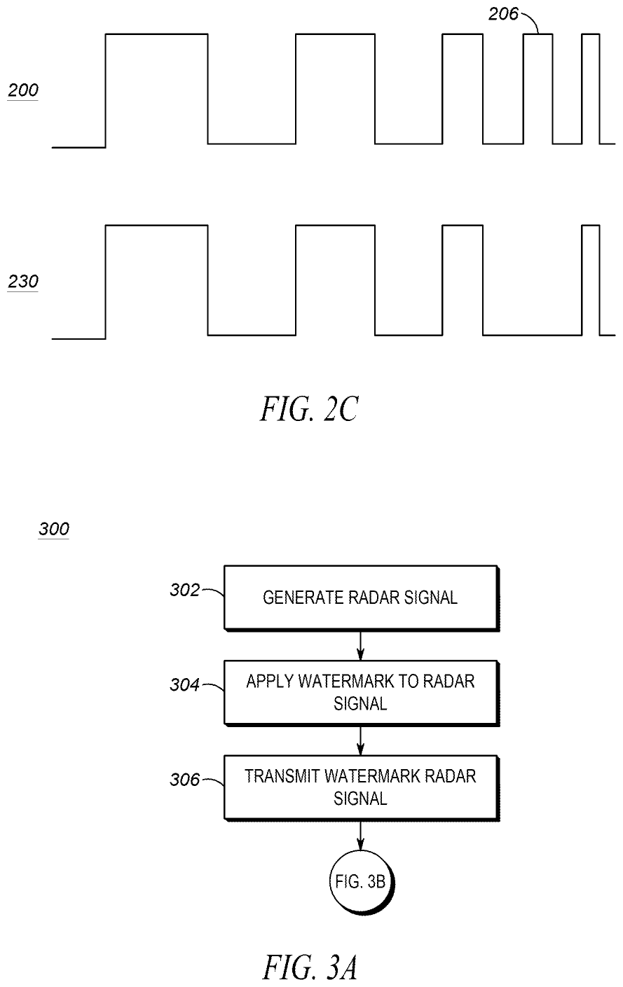

The watermark insertion module 122 is configured to manipulate the original radar signal generated by the signal generator 108 in a distinct and recognizable manner, thereby applying a watermark to the radar signal. However, the manipulation applied by the watermark insertion module 122 should be subtle enough as to be practically undetectable by ECM systems such as the DRFM system 118. Example manipulations to an original radar signal 200 are depicted in FIGS. 2A-C. While the original radar signal 200 depicted in FIGS. 2A-C takes the form of a digital LFM radar signal, it should be understood that the depicted manipulations to the original radar signal 200 can be similarly applied to radar signals of other forms as well.

As shown in FIG. 2A, in some examples, the watermark insertion module 122 may be configured to delay a particular rising edge 202 of the radar signal 200 by a known duration of time (TD). While FIG. 2A depicts the manipulation of a rising edge 202 of the radar signal 200, it should be understood that, in some examples, the watermark insertion module 122 may delay a falling edge of the radar signal 200. Further, while FIG. 2A depicts the manipulation of a single edge 202 of the radar signal 200, it should also be understood that, in some examples, the watermark insertion module 122 may delay multiple rising edges, multiple falling edges, and/or a combination of rising and falling edges of the radar signal 200. The delays inserted by module 122 in the multiple rising, multiple falling, and/or a combination of rising and falling edges may all be randomly selected, but they are all known and recorded by module 122.

As shown in FIG. 2B, in some examples, the watermark insertion module 122 may be configured to advance a particular falling edge 204 of the radar signal 200 by a known duration of time (T_{A}). Again, while FIG. 2B depicts the manipulation of a falling edge 204 of the radar signal 200, it should be understood that, in some examples, the watermark insertion module 122 may advance a rising edge of the radar signal 200. Further, while FIG. 2B depicts the manipulation of a single edge 202 of the radar signal 200, it should also be understood that, in some examples, the watermark insertion module 122 may advance multiple rising edges, multiple falling edges, and/or a combination of rising and falling edges of the radar signal 200. The advances inserted by module 122 in the multiple rising, multiple falling, and/or a combination of rising and falling edges may all be randomly selected, but they are all known and recorded by module 122.

As shown in FIG. 2C, in some examples, the watermark insertion module 122 may be configured to remove an entire pulse 206 of the radar signal 200. While FIG. 2C depicts the removal of a logic-high pulse 206 of the radar signal 200 by causing the radar signal 200 to remain logic-low throughout the duration of the pulse 206, it should be understood that, in some examples, the watermark insertion module 122 may remove a logic-low pulse of the radar signal 200 by causing the radar signal 200 to remain logic-high throughout the duration of the pulse. Further, while FIG. 2C depicts the removal of a single logic-high pulse 206 of the radar signal 200, it should also be understood that, in some examples, the watermark insertion module 122 may remove multiple logic-high pulses, multiple logic-low pulses, and/or a combination of logic-high and logic-low pulses of the radar signal 200.

Further, while FIGS. 2A-C separately depict the different types of manipulations described above, it should be understood that, in some examples, the watermark insertion module 122 may apply a combination of any of the types of manipulations depicted in FIGS. 2A-C and described above.

The watermark insertion module 122 can perform any of the signal manipulations to the radar signal 200 described above in various ways. In some examples, the watermark insertion module 122 includes a digital-to-time converter (DTC), also known as a digital delay generator. By using the DTC to generate the rising and falling edges of the radar signal 200, the watermark insertion module 122 can precisely control the timing of an individual rising or falling edge of the radar signal 200. In some examples, the watermark insertion module 122 may be integrated as part of the signal generator 108 and may apply the watermark to the radar signal 200 as part of the generation of the radar signal 200. For instance, the watermark insertion module 122 may include an arbitrary waveform generator capable of generating any arbitrarily defined waveshape based on a series of specific voltage targets and corresponding time values. However, these examples are not meant to be limiting, and the watermark insertion module 122 can include any hardware and/or software now known or later developed for performing the signal manipulations described herein.

Further, in some examples, the signal manipulation performed by the watermark insertion module 122 may be randomly or pseudorandomly influenced in order to increase the distinctiveness of the watermark. For example, the watermark insertion module 122 may be configured to randomly or pseudorandomly select the particular edge or edges that are to be time-shifted in any of the manners described above. Additionally or alternatively, the watermark insertion module 122 may be configured to randomly or pseudorandomly select the duration of any such time-shift, such as by randomly or pseudorandomly selecting a duration from within a predefined range of time durations.

In line with the discussion above, any manipulation applied by the watermark insertion module 122 should be subtle enough as to be practically undetectable by ECM systems such as the DRFM system 118. And as further noted above, the DRFM system 118 works by sampling incident radar signals at a particular sampling frequency to digitize the signals. As such, one way to make the manipulation applied by the watermark insertion module 122 undetectable by the DRFM system 118 is to make the duration of any signal manipulation (e.g., the duration of t_{d}, tₐ, or a removed pulse) smaller than the sampling capabilities of the DRFM system 118. For example, if the DRFM system 118 operates at a sampling frequency of 5 GHZ, then its Nyquist frequency (i.e., the maximum signal frequency that the DRFM system 118 can sample without aliasing effects) is 2.5 GHZ, the inverse of which corresponds to a period duration of 0.4 ns. Accordingly, in such an example, the DRFM system 118 would be unable to accurately sample and reproduce signal manipulations having a duration smaller than 0.4 ns, and the watermark insertion module 122 may be configured to limit the duration of the manipulations to the radar signal 200 accordingly. However, it should be understood that these example values are for illustrative purposes, and the durations of the manipulations applied by the watermark insertion module 122 can be increased or decreased accordingly in other examples depending on the sampling capabilities of the DRFM system 118.

Once the watermark insertion module 122 has manipulated the radar signal 200 to insert one or more watermarks into the signal, the transmitter 102 causes the antenna 106 to transmit the watermarked radar signal as the transmitted radar signal 112. Then, upon receiving the return signal 120, the antenna 106 provides the return signal 120 to the receiver 104 for signal processing and watermark detection. For instance, as noted above, the receiver 104 includes a signal processor 110 configured to apply any of the signal processing techniques described above. And as further depicted in FIG. 1B, the receiver 104 includes a watermark detection module 124 configured to analyze the return signal 120 to determine whether the return signal 120 includes the watermark applied by the watermark insertion module 122.

In order to determine whether the return signal 120 includes the watermark applied by the watermark insertion module 122, the watermark detection module 124 receives from the watermark insertion module 122 an indication of the watermark applied to the radar signal 200. In some examples, this may involve the watermark detection module 124 receiving the watermarked radar signal itself. In other examples, this may involve the watermark detection module 124 receiving the non-watermarked radar signal 200 along with data indicating the manipulations applied by the watermark insertion module 122. Such data may include an indication of the type(s) of manipulations applied by the watermark insertion module 122, such as a delayed rising edge, a delayed falling edge, an advanced rising edge, an advanced falling edge, or an omitted pulse. Such data may further include an indication of a location within the radar signal 200 where the manipulation(s) were applied, such as an indication of a time at which the manipulated edge(s) or pulse(s) occur or an indication of an ordinal position of the manipulated edge(s) or pulse(s) within an overall sequence of edges and pulses of the radar signal 200. Still further, such data may include an indication of a duration of the manipulation(s), such as an indication of a duration of time by which a manipulated edge was delayed or advanced. In any case, the watermark detection module 124 receives sufficient information to determine the characteristics of the watermarked radar signal that differentiate the watermarked radar signal from the non-watermarked radar signal 200.

The watermark detection module 124 can then analyze the return signal 120 to determine whether the return signal 120 includes the watermark applied by the watermark insertion module 122 in various ways. In some examples, the watermark detection module 124 can use hypothesis testing to determine whether the return signal 120 includes the watermark. For instance, the watermark detection module 124 may apply statistical methods to determine whether a null hypothesis is true, in which the return signal 120 more closely resembles the non-watermarked radar signal 200, or whether an alternative hypothesis is true, in which the return signal 120 more closely resembles the watermarked radar signal.

In order to perform such hypothesis testing, the watermark detection module 124 may determine one or more test statistics for characterizing aspects of the return signal 120. The test statistics may take various forms and may include any test statistic suitable for determining whether the watermark applied by the watermark insertion module 122 is present in the return signal 120-namely, whether the return signal 120 includes the same time-shifted edge(s) and/or other manipulations applied by the watermark insertion module 122. Examples of such test statistics may include time durations between consecutive edges in the return signal 120, such as time durations between consecutive rising edges, time durations between consecutive falling edges, and/or time durations between consecutive rising and falling edges. In other examples, the test statistics may include time durations for when the return signal 120 has a value corresponding to a logic high value and/or for when the return signal 120 has a value corresponding to a logic low value. Still in other examples, the test statistics may include relative time durations, such as a ratio of a time duration for when the return signal 120 has a value corresponding to a logic high value relative to a time duration when the return signal 120 has a value corresponding to a logic low value, and vice versa. It should be understood that these example test statistics are for illustrative purposes only and that, as noted above, any suitable test statistic may be used for determining whether the watermark applied by the watermark insertion module 122 is present in the return signal 120.

Then, based on the one or more test statistics characterizing the return signal 120 as well as a predefined significance level, the watermark detection module 124 may apply a decision rule to determine whether the watermark applied by the watermark insertion module 122 is present in the return signal 120.

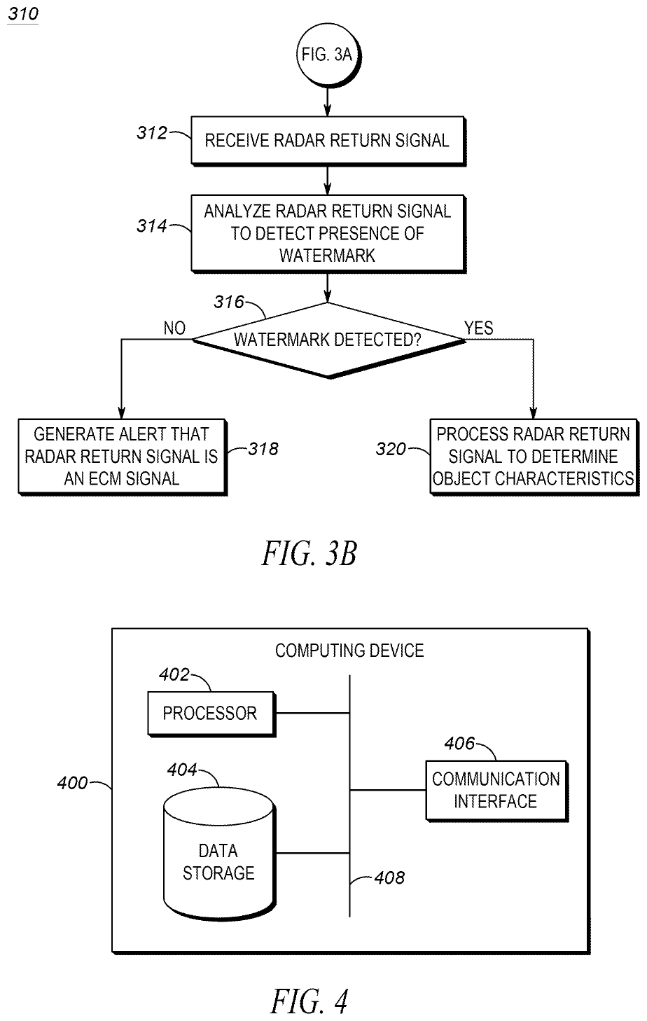

Attention is next directed to FIG. 3A and FIG. 3B, which respectively depict a flowchart of an example method 300 for generating and transmitting a watermarked radar signal for ECCM purposes and a flowchart of an example method 310 for determining whether a received radar signal is an ECM signal or a skin return signal. The operations of the methods 300, 310 depicted in FIGS. 3A and 3B correspond to computer-readable instructions that are executed by the radar system 100. In the illustrated example, the instructions are represented by the blocks of FIGS. 3A and 3B and may be stored in a data storage component of the radar system 100. Further, where possible, the methods 300, 310 need not be performed in the exact sequence as shown, and various blocks may be performed in parallel rather than in sequence.

Turning now to FIG. 3A, at block 302 the method 300 involves generating a radar signal. In line with the discussion above, this may involve the signal generator 108 generating a pulse modulated radar signal, such as an LFM radar signal, or a CW radar signal.

At block 304, the method 300 involves applying a watermark to the radar signal. This may involve the watermark insertion module 122 applying a watermark in any of the manners described above and/or depicted in FIGS. 2A-2C. For instance, applying a watermark to the radar signal may involve manipulating the radar signal by advancing and/or delaying one or more rising and/or falling edges of the radar signal and/or removing one or more pulses of the radar signal. Further, as also described above, the extent of the manipulations to the radar signal should be subtle enough to be practically undetectable by an ECM system, such as a sampling device of the DRFM system 118.

At block 306, the method 300 involves transmitting the watermarked radar signal. In line with the discussion above, this may involve the transmitter 102 causing the transmitting antenna 106 to transmit the watermarked radar signal in a particular direction (e.g., toward an object of interest such as the aircraft 114) as transmitted signal 112.

Turning next to FIG. 3B, after transmitting the watermarked radar signal, the radar system 100 may perform the method 310 for determining whether a received radar signal is an ECM signal or a skin return signal. At block 312, the method 310 involves receiving a radar return signal. In line with the discussion above, this may involve the receiving antenna 106 receiving a radar return signal and providing the return signal to the receiver 104.

At block 314, the method 310 involves analyzing the radar return signal to detect the presence of the watermark that was applied at block 304. In line with the discussion above, this may involve the watermark detection module 124 performing hypothesis testing on the return signal to evaluate the likelihood that the return signal includes a signal manipulation corresponding to the applied watermark. Further, in some examples, the signal processor 110 may apply one or more signal processing techniques to the return signal in advance of and/or in preparation for the watermark detection module 124 performing the hypothesis testing.

At block 316, the method 310 involves determining, based on the analysis at block 314, whether the watermark is present in the radar return signal. If the determination is that the watermark is not present in the return signal, then this may indicate that an ECM system, such as the DRFM system 118, has intercepted the transmitted radar signal 112 and has attempted to retransmit the radar signal with deceptive ECM manipulations applied to the signal. Accordingly, the method 310 advances to block 318, which involves generating and outputting an alert that the return signal is an ECM signal. The alert may take various forms and may include an audio and/or visual alert, such as an alarm, a light, and/or a message indicating that the received radar return signal is an ECM signal.

If, on the other hand, the determination at block 316 is that the watermark is present in the radar return signal, then this may indicate that the received radar signal is a legitimate skin return signal that reflected off of a target object (e.g., the aircraft 114) without any ECM manipulations. Accordingly, the method 310 advances to block 320, which involves the signal processor 110 processing the radar return signal according to any of the radar signal processing techniques described above to determine various characteristics of the target object, such as position (e.g., range, azimuth, altitude), velocity, heading, and size. In some examples, block 320 may further involve outputting an indication that the received radar signal is a skin return signal. The indication may be an explicit indication, such as an audiovisual indicator and/or message, or the indication may be an implicit indication, such as by outputting the determined characteristics of the target object.

Attention is next directed to FIG. 4, which depicts a schematic block diagram of an example computing device 400. The computing device 400 may represent a structure of any suitable component of the radar system 100, including, but not limited to, the transmitter 102, the receiver 104, the signal generator 108, the signal processor 110, the watermark insertion module 122, and the watermark detection module 124. While the computing device 400 is depicted in FIG. 4 as a single component, when the computing device 400 represents a structure of the radar system 100, functionality of the computing device 400 may be distributed among a plurality of components. Further, in such examples, functionality of the transmitter 102, the receiver 104, the signal generator 108, the signal processor 110, the watermark insertion module 122, and the watermark detection module 124 may be combined in any suitable manner.

As depicted, the computing device 400 includes at least a processor 402, a data storage 404, and a communication interface 406, all of which may be communicatively linked by a communication link 408, which may take the form of a system bus or some other connection mechanism.

The processor 402 may comprise one or more processor components, such as general-purpose processes (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed.

The data storage 404 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. The data storage 404 may also be provisioned with software components that enable the computing system 400 to carry out the operations disclosed herein. These software components may generally take the form of program instructions that are executable by the processor 402 to carry out the disclosed operations.

The communication interface 406 may be configured to facilitate wired and/or wireless communication with other computing devices or systems. As such, the communication interface 406 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wired and/or wireless communication. The communication interface 406 may also include multiple communication interfaces of different types. Other configurations are possible as well.

Although not shown, the computing device 400 may additionally include one or more other interfaces that provide connectivity with external user-interface components (sometimes referred to as “peripherals”), such as a keyboard, a mouse or trackpad, a display screen, a touch-sensitive interface, a stylus, a microphone, a headset, speakers, etc., which may allow for direct user interaction with the computing device 400.

It should be understood that the computing device 400 is one example of a computing device that may be used with the embodiments described herein. Numerous other arrangements are possible and contemplated herein. For instance, other computing devices may include additional components not pictured and/or more or fewer of the pictured components.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot generate, manipulate, transmit, receive, and process watermarked radar signals, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A radar system comprising:
one or more processors; and
a non-transitory computer-readable medium having stored thereon program instructions that, when executed by the one or more processors, cause the radar system to perform a set of operations comprising:
generating an initial radar signal comprising a plurality of rising and falling edges;
inserting a watermark into the initial radar signal by applying a time shift of a predetermined duration to a particular rising or falling edge from among the plurality of rising and falling edges, thereby producing a watermarked radar signal;
transmitting the watermarked radar signal;
identifying a received radar signal;
determining whether the received radar signal includes a time-shifted rising or falling edge corresponding to the inserted watermark;
based on the determination of whether the received radar signal includes the time-shifted rising or falling edge corresponding to the inserted watermark, determining whether the received radar signal is a skin return signal or an electronic countermeasure signal; and
outputting an indication of whether the received radar signal is a skin return signal or an electronic countermeasure signal.

2. The radar system of claim 1, wherein:
determining whether the received radar signal includes a time-shifted rising or falling edge corresponding to the inserted watermark comprises determining that the received radar signal does not include a time-shifted rising or falling edge corresponding to the inserted watermark;
determining whether the received radar signal is a skin return signal or an electronic countermeasure signal comprises determining that the received radar signal is an electronic countermeasure signal based on the determination that the received radar signal does not include a time-shifted rising or falling edge corresponding to the inserted watermark; and
outputting the indication of whether the received radar signal is a skin return signal or an electronic countermeasure signal comprises outputting an indication that the received radar signal is an electronic countermeasure signal.

3. The radar system of claim 1, wherein:
determining whether the received radar signal includes a time-shifted rising or falling edge corresponding to the inserted watermark comprises determining that the received radar signal does include a time-shifted rising or falling edge corresponding to the inserted watermark;
determining whether the received radar signal is a skin return signal or an electronic countermeasure signal comprises determining that the received radar signal is a skin return signal based on the determination that the received radar signal does include a time-shifted rising or falling edge corresponding to the inserted watermark; and
outputting the indication of whether the received radar signal is a skin return signal or an electronic countermeasure signal comprises outputting an indication that the received radar signal is skin return signal.

4. The radar system of claim 1, wherein inserting the watermark into the initial radar signal comprises randomly or pseudorandomly selecting the particular rising or falling edge from among the plurality of rising and falling edges in the initial radar signal to be time-shifted by the predetermined duration.

5. The radar system of claim 1, wherein inserting the watermark into the initial radar signal comprises applying a plurality of respective time shifts to a plurality of respective rising or falling edges from among the plurality of rising and falling edges.

6. The radar system of claim 5, wherein the plurality of respective time shifts comprises a first time shift of a first predetermined duration and a second time shift of a second predetermined duration different from the first predetermined duration.

7. The radar system of claim 1, wherein the predetermined duration of the time shift is less than a duration of the inverse of an expected Nyquist frequency of an electronic countermeasure system.

8. A method comprising:
generating an initial radar signal comprising a plurality of rising and falling edges;
inserting a watermark into the initial radar signal by applying a time shift of a predetermined duration to a particular rising or falling edge from among the plurality of rising and falling edges, thereby producing a watermarked radar signal;
transmitting the watermarked radar signal;
identifying a received radar signal;
determining whether the received radar signal includes a time-shifted rising or falling edge corresponding to the inserted watermark;
based on the determination of whether the received radar signal includes the time-shifted rising or falling edge corresponding to the inserted watermark, determining whether the received radar signal is a skin return signal or an electronic countermeasure signal; and
outputting an indication of whether the received radar signal is a skin return signal or an electronic countermeasure signal.

9. The method of claim 8, wherein:
determining whether the received radar signal includes a time-shifted rising or falling edge corresponding to the inserted watermark comprises determining that the received radar signal does not include a time-shifted rising or falling edge corresponding to the inserted watermark;
determining whether the received radar signal is a skin return signal or an electronic countermeasure signal comprises determining that the received radar signal is an electronic countermeasure signal based on the determination that the received radar signal does not include a time-shifted rising or falling edge corresponding to the inserted watermark; and
outputting the indication of whether the received radar signal is a skin return signal or an electronic countermeasure signal comprises outputting an indication that the received radar signal is an electronic countermeasure signal.

10. The method of claim 8, wherein:
determining whether the received radar signal includes a time-shifted rising or falling edge corresponding to the inserted watermark comprises determining that the received radar signal does include a time-shifted rising or falling edge corresponding to the inserted watermark;
determining whether the received radar signal is a skin return signal or an electronic countermeasure signal comprises determining that the received radar signal is a skin return signal based on the determination that the received radar signal does include a time-shifted rising or falling edge corresponding to the inserted watermark; and
outputting the indication of whether the received radar signal is a skin return signal or an electronic countermeasure signal comprises outputting an indication that the received radar signal is skin return signal.

11. The method of claim 8, wherein inserting the watermark into the initial radar signal comprises randomly or pseudorandomly selecting the particular rising or falling edge from among the plurality of rising and falling edges in the initial radar signal to be time-shifted by the predetermined duration.

12. The method of claim 8, wherein inserting the watermark into the initial radar signal comprises applying a plurality of respective time shifts to a plurality of respective rising or falling edges from among the plurality of rising and falling edges.

13. The method of claim 12, wherein the plurality of respective time shifts comprises a first time shift of a first predetermined duration and a second time shift of a second predetermined duration different from the first predetermined duration.

14. The method of claim 8, wherein the predetermined duration of the time shift is less than a duration of the inverse of an expected Nyquist frequency of an electronic countermeasure system.

15. A non-transitory computer-readable medium comprising program instructions that are executable by one or more processors to cause a radar system to perform a set of operations comprising:
generating an initial radar signal comprising a plurality of rising and falling edges;
inserting a watermark into the initial radar signal by applying a time shift of a predetermined duration to a particular rising or falling edge from among the plurality of rising and falling edges, thereby producing a watermarked radar signal;
transmitting the watermarked radar signal;
identifying a received radar signal;
determining whether the received radar signal includes a time-shifted rising or falling edge corresponding to the inserted watermark;
based on the determination of whether the received radar signal includes the time-shifted rising or falling edge corresponding to the inserted watermark, determining whether the received radar signal is a skin return signal or an electronic countermeasure signal; and
outputting an indication of whether the received radar signal is a skin return signal or an electronic countermeasure signal.

16. The non-transitory computer-readable medium of claim 15, wherein:
determining whether the received radar signal includes a time-shifted rising or falling edge corresponding to the inserted watermark comprises determining that the received radar signal does not include a time-shifted rising or falling edge corresponding to the inserted watermark;
determining whether the received radar signal is a skin return signal or an electronic countermeasure signal comprises determining that the received radar signal is an electronic countermeasure signal based on the determination that the received radar signal does not include a time-shifted rising or falling edge corresponding to the inserted watermark; and
outputting the indication of whether the received radar signal is a skin return signal or an electronic countermeasure signal comprises outputting an indication that the received radar signal is an electronic countermeasure signal.

17. The non-transitory computer-readable medium of claim 15, wherein:
determining whether the received radar signal includes a time-shifted rising or falling edge corresponding to the inserted watermark comprises determining that the received radar signal does include a time-shifted rising or falling edge corresponding to the inserted watermark;
determining whether the received radar signal is a skin return signal or an electronic countermeasure signal comprises determining that the received radar signal is a skin return signal based on the determination that the received radar signal does include a time-shifted rising or falling edge corresponding to the inserted watermark; and
outputting the indication of whether the received radar signal is a skin return signal or an electronic countermeasure signal comprises outputting an indication that the received radar signal is skin return signal.

18. The non-transitory computer-readable medium of claim 15, wherein inserting the watermark into the initial radar signal comprises randomly or pseudorandomly selecting the particular rising or falling edge from among the plurality of rising and falling edges in the initial radar signal to be time-shifted by the predetermined duration.

19. The non-transitory computer-readable medium of claim 15, wherein inserting the watermark into the initial radar signal comprises applying a plurality of respective time shifts to a plurality of respective rising or falling edges from among the plurality of rising and falling edges.

20. The non-transitory computer-readable medium of claim 19, wherein the plurality of respective time shifts comprises a first time shift of a first predetermined duration and a second time shift of a second predetermined duration different from the first predetermined duration.
